(19) United States
(12) Patent Application Publication
(10) Pub. No.: US 2013/0173286 A1
(43) Pub. Date: Jul. 4, 2013

(54) METHOD FOR FACILITATING PHARMACEUTICAL COST SAVING BY PILL SPLITTING

(71) Applicant: Gary Abeles, Verona, NJ (US)

(72) Inventor: Gary Abeles, Verona, NJ (US)

(21) Appl. No.: 13/726,814

(22) Filed: Dec. 26, 2012

Related U.S. Application Data
(60) Provisional application No. 61/581,663, filed on Dec. 30, 2011.

(51) Int. Cl. G06F 19/00

(52) U.S. Cl. CPC G06F 19/3456
USPC 705/2

(57) ABSTRACT

A method for facilitating pill splitting includes evaluating prescription pills regarding their hardness, fragility, structural features such as encapsulation and/or time release, uniformity of composition, availability with scoring, and/or criticality of dosage to determine candidates for pill splitting. Pharmaceutical price databases can be reviewed for flat pricing to predict cost savings due to splitting of higher dosage pills. In embodiments, pharmacies are identified that are willing to score and/or split pills before dispensation. Guidelines for evaluating suitability of patients for patient pill splitting can also be included. The information is provided to doctors, and in embodiments also to medical insurers, government agencies, and/or patients. The information can be mailed, posted on a website, and/or sent by electronic messaging. Revenue can result from subscriptions, grants, and advertising.

### RELATED APPLICATIONS

This application claims the benefit of U.S. Provisional Application No. 61/581,663, filed Dec. 30, 2011, which is herein incorporated by reference in its entirety for all purposes.

### FIELD OF THE INVENTION

The invention relates to health care cost management, and more particularly, to pill splitting.

### BACKGROUND OF THE INVENTION

The practice of “tablet splitting,” also known as “pill splitting,” is well known, but is not widely practiced for reasons that are described in more detail below. Reasons for splitting a pill into halves, or even into smaller pieces, include adjustment of the dose (for example for use by children) and reducing the likelihood of side effects. Pill splitting is sometimes recommended by doctors for various reasons, including off-label applications of the drug. For example, the “label” use of an aspirin is to relieve pain, and standard aspirin pill doses are adjusted accordingly to about 325 mg. However, aspirin has also been found to reduce the risk of a heart attack or stroke, and studies have shown that 160 mg or less per day is effective for that purpose. Therefore, doctors sometimes recommend that their patients take ½ aspirin tablet per day as an equally effective and safer dose for reducing heart attack and stroke risk.

Perhaps an even stronger motivation for pill splitting is to save cost. The high cost of prescription drugs places an undue burden on both uninsured and insured patients, state and federally funded programs, and health insurance companies.

Pharmaceutical manufacturing is a multi-billion dollar industry, with sales of many blockbuster drugs exceeding billions of dollars per drug annually. For many pharmaceutical drugs, most of the cost arises from research and development, obtaining government approval, marketing, packaging, and distribution. The actual per-dosage cost of the active ingredient in many drugs is often vanishingly small. Thus, for both practical and marketing reasons, pharmaceutical manufacturers often sell their medications at prices that are independent, or nearly independent, of the dosage. For example the per-pill cost of a 10 mg dose of Lipitor costs the same as a 20 mg dose and a 40 mg dose. Because of this “flat” pricing approach, purchasing a medication at a higher dosage and then splitting the pills can often result in a cost saving to consumers and/or to insurance companies of as much as 50% or more. If this practice were widespread, billions of dollars in pharmaceutical expenses could be saved.

Simple, low cost devices are readily available for use by patients to split pills in half, and scoring of pills can lead to highly accurate splitting. However, while scoring is common for pills produced for veterinary medicine, it is not common for the pills sold to humans at pharmacies. Pill dispensing devices are known that will automatically split pills as they are dispensed. However, such devices are not widely used by pharmacies.

Not surprisingly, medical insurance companies are often in favor of pill splitting. Some of them provide to their patients lists of drugs approved for splitting, and some even effectively require their patients to pill-split by not covering the cost of certain lower-dose drugs, and thereby effectively forcing patients to purchase the drugs in higher doses and split the pills.

Nevertheless, there are several potential problems associated with pill splitting. The split fragments may not be equal in size, or the dosages may be unequal for other reasons, such as an unequal distribution of ingredients within the pill. This can happen even if the pill is scored and split cleanly down the middle.

Some tablets are difficult to split, either because they are too hard and tend to shatter, or they are too fragile and tend to crumble. Also, some patients may fail to use a pill-splitting tool correctly, or may attempt to split pills using a simple knife, or by breaking them by hand.

And some pills simply should not be split due to their design. For example, capsules and coated time-release drugs are typically not safe to split, and some pills may include a coating that protects the user from a highly objectionable taste.

In addition, some patients may not be good candidates for patient pill splitting. Some patients may lack the physical ability to split pills reliably, due to poor physical abilities and/or poor eyesight. Patients may also simply fail to understand the importance of following proper procedures. They may mix the split fragments of many pills together rather than taking the fragments of the same pill sequentially, thereby causing greater fluctuations in dosage. They may find it too inconvenient to split the pills, and simply take them every other day. Even worse, patients may forget or may fail to understand (e.g. due to a language barrier) that the pills should be split, and may take them at twice the prescribed dosage.

For reasons such as these, the US FDA Office of Pharmaceutical Science has issued the following statement: “[The] FDA does not encourage the practice of tablet splitting unless it's specified in the drug's professional prescribing information. If a patient is considering splitting a tablet, FDA recommends that the patient get advice directly from his or her doctor or pharmacist to determine whether it is appropriate or not for a particular drug.”

As mentioned above, drug manufacturers have a financial incentive to discourage pill splitting, and so they are not eager to specify splitting in their prescribing information. In the face of the above US FDA statement, and in the absence of any positive instructions by the drug manufacturers, doctors are often hesitant to prescribe drugs in larger sizes for splitting. And while the practice would not be illegal in most jurisdictions, pharmacists typically do not want to split pills without a directive to do so from a doctor or from some other authority.

Nevertheless, many commonly used drugs are known to be good candidates for pill splitting. For example, an article in the August, 2002 issue of The American Journal of Managed Care (Vol 8, No. 8, p. 707, included herein by reference for all purposes) presents a methodology for identifying specific medications for which pill splitting is clinically appropriate and cost saving, and identified eleven medications amenable to pill splitting based on potential cost savings and clinical appropriateness: clonazepam, doxazosin, atorvastatin, pravastatin, citalopram, sertraline, paroxetine, lisinopril, nefazadone, olanzapine, and sildenafil.

What is needed, therefore, is a method for reducing the barriers and risks associated with pill splitting, so that the cost savings and other benefits of pill splitting can be more widely realized.

### SUMMARY OF THE INVENTION

The present invention is a method for reducing the risks and barriers associated with pill splitting, and thereby enabling the cost savings and other benefits of pill splitting to be more widely realized.

The method includes evaluating prescription drugs according to their physical properties (hardness and tendency to shatter or fragility and tendency to crumble), uniformity of composition, structure (e.g. time release features), availability with scoring, and criticality of dosage amount. Based on the evaluations, candidates for pill splitting are determined, and in some embodiments rated. In embodiments, pharmaceutical price databases are also reviewed to identify how much cost savings, if any, can be realized by pill splitting. In some embodiments, pharmacies that are willing to score and/or split pills for patients are also identified.

The information thus obtained is provided to doctors for consideration in prescribing medications. In embodiments, the information is also provided to health care insurers, government agencies, pharmacists, and/or to patients. In various embodiments, the information is provided by mail, for example in a newsletter, on a website, and/or by text message, tweet, and/or other electronic messaging.

In embodiments, revenue to offset the cost of obtaining and providing the information and to provide a profit is obtained from health care providers, health care insurance providers, and/or government agencies. The revenue can be obtained directly as subscription payments and/or indirectly in the form of government and/or industry grants and/or from advertisements distributed with the information.

In certain embodiments, guidelines are also provided to physicians for determining which patients are appropriate for patient pill splitting. These can include evaluation of the patient's (or the patient's care-giver's) language and cognizant abilities, for example to determine if the splitting instructions will be understood, and physical abilities, for example to determine if the patient can see well enough and manipulate a splitting device with sufficient accuracy.

Typically, in many countries a claim by a pharmacy to a health-care insurance provider, government agency, or PBM (herein referred to generically as an “insurance provider” unless otherwise required by context) for coverage of a medication is more or less instantly adjudicated at the pharmacy thru a point of service online database to verify patient eligibility, drug eligibility, drug price, patient co-pay amount, and other details. Often, information is also provided regarding patient options to reduce cost, such as by selecting a generic alternative or a different brand-name drug.

Similarly, in embodiments of the present invention, instant notification is also provided to a pharmacy during adjudication of an insurance coverage claim regarding the eligibility of a medication for pill-splitting, and in some of these embodiments also regarding tiered pricing and/or tiered co-payments available when pill-splitting is elected. In some of these embodiments, the pharmacist evaluates the physical and mental ability of the patient to follow the appropriate pill-splitting procedures, and ensures that the patient owns an appropriate pill-splitting device. For example, this can be done while informing the patient regarding the required procedures and teaching the patient how to use a pill-splitting device. In various embodiments, depending on the available apparatus and policies of the pharmacy, the pharmacist may score and/or split the pills for the patient before dispensing them.

The present invention is a method for facilitating pill splitting of prescription medications. The method includes evaluating medications available for prescription as pills regarding their suitability for pill splitting, identifying medications that are suitable for pill splitting, and distributing to health care providers information regarding the identified medications suitable for pill splitting.

In embodiments, evaluating the medications includes evaluating a hardness of the pills containing the medications. In some embodiments, evaluating the medications includes evaluating a fragility of the pills containing the medications. In other embodiments evaluating the medications includes evaluating a distribution uniformity of the medication in the pills. In certain embodiments, evaluating the medications includes evaluating physical structures of the pills containing the medications. And in various embodiments evaluating the medications includes evaluating an availability of scoring of the pills containing the medications.

In embodiments, evaluating the medications includes evaluating a sensitivity to dosage variation of the medications. In some embodiments evaluating the medications includes evaluating relative pricing at different dosage levels of the pills containing the medications. And in certain embodiments evaluating the medications includes rating the medications according to their relative suitability for pill splitting.

In various embodiments distributing the information to health care providers includes providing the information electronically.

Certain embodiments further include distributing the information regarding the identified medications suitable for pill splitting to a pharmaceutical cost reimbursing entity. Some of these embodiments further include providing by the pharmaceutical cost reimbursing entity to a pharmacy of pill splitting information relevant to one of the identified medications during adjudication of a claim on behalf of a patient for coverage of the identified medication. And some of these embodiments further include evaluating by a staff member of the pharmacy of the patient's physical and mental ability to follow pill-splitting procedures.

Various embodiments further include distributing the information regarding the identified medications suitable for pill splitting to pharmaceutical patients.

Some embodiments further include identifying pharmacies that are willing to score pills before dispensing them, and including information regarding the identified pharmacies with the information regarding the identified medications suitable for pill splitting.

Other embodiments further include identifying pharmacies that are willing to split pills before dispensing them, and including information regarding the identified pharmacies with the information regarding the identified medications suitable for pill splitting.

Certain embodiments further include developing guidelines for evaluating suitability of patents for pill splitting, and including the guidelines with the information regarding the identified medications suitable for pill splitting.

Embodiments further include receiving subscription revenue from parties to whom the information regarding the identified medications suitable for pill splitting is provided. Some embodiments further include receiving grant revenue from parties interested in promoting pill splitting. And other embodiments further include receiving advertising revenue resulting from advertisements that are provided together with the information regarding the identified medications suitable for pill splitting.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a flow diagram illustrating an embodiment of the invention; and

FIG. 2 is a flow diagram illustrating distribution of pill-splitting information to a pharmacy by an insurance company during adjudication of a claim for drug coverage.

### DETAILED DESCRIPTION

The present invention is a method for reducing the risks and barriers associated with pill splitting, and thereby enabling the cost savings and other benefits of pill splitting to be more widely realized.

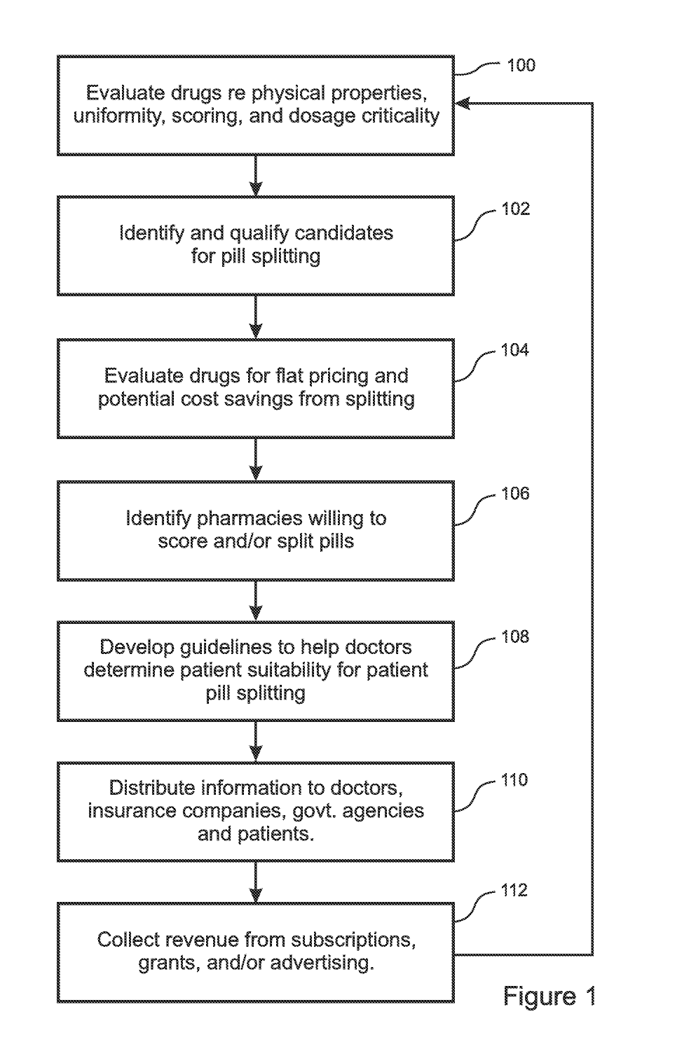

With reference to FIG. 1, the method of the present invention includes evaluating prescription drugs 100 according to their physical properties (hardness and tendency to shatter, or fragility and tendency to crumble), uniformity of composition, structure (e.g. time release features), availability with scoring, and criticality of dosage amount. Pharmaceutical candidates for pill splitting are thereby identified 102, and in some embodiments rated. In embodiments, at least one pharmaceutical price database is also reviewed 104 to identify how much cost savings, if any, can be realized by pill splitting for each of the splitting candidates. In some embodiments, pharmacies that are willing to score and/or split pills for patients are also identified 106.

In certain embodiments, guidelines are also developed 108 for determining which patients are appropriate for patient pill splitting. These can include guidelines for evaluating a patient's (or a patient's care-giver's) language and cognizant abilities, for example to determine if the splitting instructions will be understood and followed, and for evaluating a patient's physical abilities, for example to determine if the patient can see well enough and manipulate the splitting device with sufficient accuracy, and has sufficient muscle control and strength.

The information and guidelines thus obtained are provided to doctors 110 for consideration in prescribing medications. In embodiments, the information is also provided to health care insurers, government agencies, PBM's, pharmacists, and/or patients. In various embodiments, the information is provided by mail (for example in a newsletter), on a website, and/or by text message, tweet, and/or other electronic delivery means.

In embodiments, revenue to offset the cost of obtaining and providing the information, and to provide a profit, is obtained from health care providers, health care insurance providers, and/or government agencies 112. The revenue can be obtained directly as subscription payments and/or indirectly from government grants, industry grants, and/or advertisements distributed with the information.

In embodiments, the steps of reviewing, identifying, evaluating, and distributing information are repeated periodically to keep the information up to date, and to remind care givers and patients of the options available for pill splitting.

Typically, in many countries a claim by a pharmacy to a health-care insurance provider, government agency, or PBM (herein referred to generically as an “insurance provider” unless otherwise required by context) for coverage of a medication is more or less instantly adjudicated at the pharmacy thru a point of service online database to verify patient eligibility, drug eligibility, drug price, patient co-pay amount, and other details. Often, information is also provided regarding patient options to reduce cost, such as by selecting a generic alternative or a different brand-name drug.

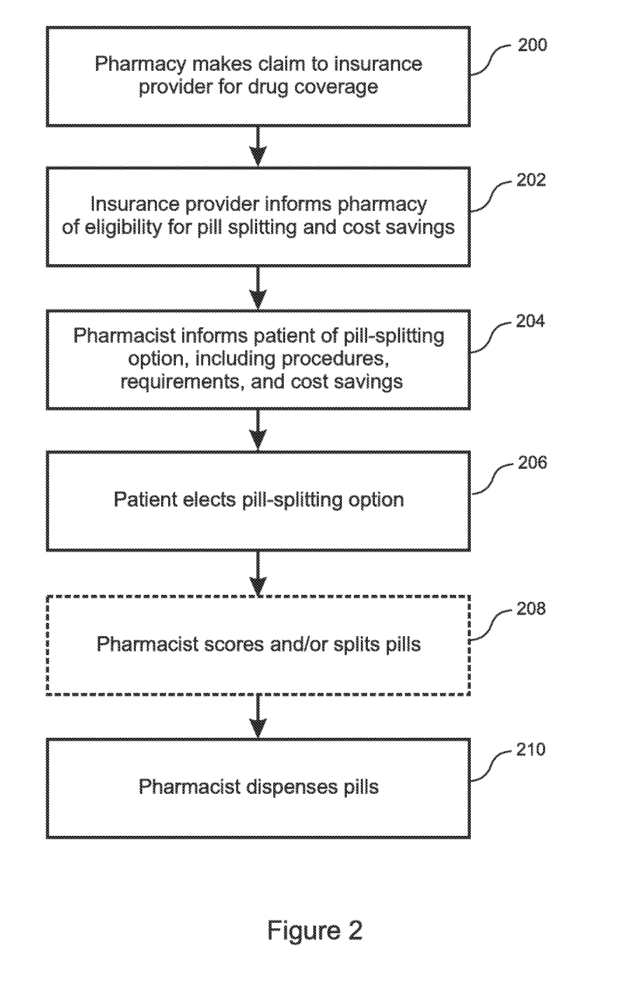

With reference to FIG. 2, in embodiments of the present invention when a pharmacy makes a claim to an insurance provider for coverage of a drug 200, substantially instant notification is also provided to the pharmacy during adjudication regarding the eligibility of the drug for pill-splitting, and in some of these embodiments also regarding reduced pricing and/or reduced co-payments that apply when pill-splitting is elected 202. The pharmacy then informs the patient of the requirements and potential cost benefits of pill splitting 204. A pharmacist may also ask questions and/or use other means to evaluate the patient's ability to understand and follow pill splitting procedures. For example, as part of this evaluation the pharmacist may show the patient how to use a simple device to split a pill, and in the process the pharmacist may verify that the patient owns an appropriate apparatus and has the physical and mental ability required to use it. In some embodiments, if the patient qualifies and elects pill splitting 206, the pharmacist may score and/or split the tablets for the patient 208 before dispensing them 210.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A method for facilitating pill splitting of prescription medications, the method comprising:
evaluating medications available for prescription as pills regarding their suitability for pill splitting;
identifying medications that are suitable for pill splitting; and
distributing to health care providers information regarding the identified medications suitable for pill splitting.

2. The method of claim 1, wherein evaluating the medications includes evaluating a hardness of the pills containing the medications.

3. The method of claim 1, wherein evaluating the medications includes evaluating a fragility of the pills containing the medications.

4. The method of claim 1, wherein evaluating the medications includes evaluating a distribution uniformity of the medication in the pills.

5. The method of claim 1, wherein evaluating the medications includes evaluating physical structures of the pills containing the medications.

6. The method of claim 1, wherein evaluating the medications includes evaluating an availability of scoring of the pills containing the medications.

7. The method of claim 1, wherein evaluating the medications includes evaluating a sensitivity to dosage variation of the medications.

8. The method of claim 1, wherein evaluating the medications includes evaluating relative pricing at different dosage levels of the pills containing the medications.

9. The method of claim 1, wherein evaluating the medications includes rating the medications according to their relative suitability for pill splitting.

10. The method of claim 1, wherein distributing the information to health care providers includes providing the information electronically.

11. The method of claim 1, further comprising distributing the information regarding the identified medications suitable for pill splitting to a pharmaceutical cost reimbursing entity.

12. The method of claim 11, further comprising providing by the pharmaceutical cost reimbursing entity to a pharmacy of pill splitting information relevant to one of the identified medications during adjudication of a claim on behalf of a patient for coverage of the identified medication.

13. The method of claim 12, further comprising evaluating by a staff member of the pharmacy of the patient's physical and mental ability to follow pill-splitting procedures.

14. The method of claim 1, further comprising distributing the information regarding the identified medications suitable for pill splitting to pharmaceutical patients.

15. The method of claim 1, further comprising identifying pharmacies that are willing to score pills before dispensing them, and including information regarding the identified pharmacies with the information regarding the identified medications suitable for pill splitting.

16. The method of claim 1, further comprising identifying pharmacies that are willing to split pills before dispensing them, and including information regarding the identified pharmacies with the information regarding the identified medications suitable for pill splitting.

17. The method of claim 1, further comprising developing guidelines for evaluating suitability of patents for pill splitting, and including the guidelines with the information regarding the identified medications suitable for pill splitting.

18. The method of claim 1, further comprising receiving subscription revenue from parties to whom the information regarding the identified medications suitable for pill splitting is provided.

19. The method of claim 1, further comprising receiving grant revenue from parties interested in promoting pill splitting.

20. The method of claim 1, further comprising receiving advertising revenue resulting from advertisements that are provided together with the information regarding the identified medications suitable for pill splitting.
